(19) United States
(12) Patent Application Publication
(10) Pub. No.: US 2007/0042207 A1
(43) Pub. Date: Feb. 22, 2007

(54) Biodegradable multi-layer film

(76) Inventors: Werner Berger, Dresden (DE); Fritz P.E.A. De Jong, Dresden (DE)

Correspondence Address: GUDRUN E. HUCKETT DRAUDT, LONSSTR. 53, WUPPERTAL, 42289, DE

(21) Appl. No.: 10/538,020

(22) PCT Filed: Dec. 9, 2003
(86) PCT No.: PCT/DE03/04157

§ 371 Date: Jun. 7, 2005

(30) Foreign Application Priority Data
Dec. 9, 2002 (DE) 102-58277.0

(51) Int. Cl. B32B 27/36; B29C 47/06

(52) U.S. Cl. 428/480; 264/173.16

(57) ABSTRACT

A coextruded multi-layer film has at least one starch blend layer of a modified thermoplastic starch blend that contains more than 1% to 10% water and at least one polyester layer of a biodegradable polyester. The starch blend layer contains no polyhydroxyalkanoate copolymer of at least a first and a second randomly repeating monomer units. The coextruded multi-layer film is stretched after coextrusion and is suitable for packaging food.

The invention relates to a biodegradable multi-layer film with an adjustable barrier effect relative to oxygen (O₂), nitrogen (N₂), carbon dioxide (CO₂), and water vapor for use in the packaging industry, in particular, for food or in agriculture, as well as a method for its manufacture.

The following requirements are usually posed on packaging materials, especially for food:
minimal oxygen permeability (oxygen penetrability),
minimal water vapor penetrability,
excellent mechanical properties,
sealing capability,
stretching capability,
excellent processability in packaging,
inexpensive manufacture,
safe for food,
inexpensive and environmentally friendly disposal.

Packaging materials for fruits and vegetables must also be able to accommodate the natural breathing and ripening process of these products by providing a controlled oxygen and water vapor permeation.

In order to fulfill the requirements of minimal permeability for gases such as O₂, N₂, and CO₂, in the past years mono-layer and multi-layer films on the basis of synthetic polymers have been developed.

In order to fulfill the multitude of requirements, within one film different materials and their different properties are usually combined. The combination of different materials is realized either by:
lamination: subsequent application of a laminate layer on a base layer;
coextrusion: simultaneous production of several layers in one working step;
blend manufacture: mixing of the materials and extrusion to a layer.

Prerequisites for excellent properties of use of the film are comparable melting points and viscosities of the components during extrusion or coextrusion. These parameters should be very close or can be approximated relative to one another by additives such as compatibilizers or bonding agents, or other additives.

When producing laminated films by melt coating, the requirements with regard to these parameters are not as high as for the other aforementioned methods. The lamination by solvent application is very complex and expensive. Also, the adhesion of the laminate layer on the base layer is usually insufficient.

For packaging films in the food industry, films of synthetic materials are still mostly used today. They are often comprised of polyvinyl chloride or polyvinylidene chloride. For several years now, also multi-layer films of alternative chlorine-free materials, for example, polyamide, polyethylene, polyvinyl alcohol, have been used. In order to fulfill the criterion of minimal gas permeability, they are also partially coated with aluminum or silicon compounds.

A disadvantage is that these films on the basis of synthetic polymers are not biodegradable. Because of the lack of environmental safety and because of the high disposal costs, it has been attempted in the last few years to replace these materials with biodegradable materials on the basis of renewable raw materials.

Materials on the basis of biodegradable polymers and renewable raw materials are described in overviews in the following publications:
J. Schröter, Biologisch abbaubare Werkstoffe (BAW), Kunststoffe 89, (1999) 4, pages 101-104;
F. Reckert, Biologisch abbaubare Kunststoffe, Kunststoffe 92 (2002) 1, pages 78-79.

Processing of these renewable biological raw materials is much more difficult than that of synthetic polymers. A reason for the difficult processability resides, for example, in the case of starch, in that it has no defined melting range and only a minimal melt stability. In order to obtain satisfactory melting properties and to become processable, the starch must be pretreated.

Thermoplastic starch (TPS) is obtained, for example, by processing with glycerine and water (WO9005161).

In order to employ thermoplastic starch as a processable and utilizable material, it must be processed as a blend with other materials in the melt (DE 199 38 672 and DE 100 62 848). Such blends comprised of starch and thermoplastic polymers are disclosed in DE 195 13 237 A1 and DE 969212557 T2.

WO 02/059198 A1 discloses a mixture of polydihydroxy diacid esters, having defined molecular weight and melting points, and of polylactate. The mixture may contain starch.

Known are methods for cross-linking the starch surface which leads to improvement of the water resistance and permeation behavior (U.S. Pat. No. 6,242,102).

Disclosed in WO 9001043 are aliphatic polyesters (polyhydroxy carboxylic acids) that in solution can be laminated onto pre-manufactured films of hydrophilic polymers, for example, starch. In this connection, the solvents are evaporated after the coating process.

EP 0616569 B1 discloses a laminated film on the basis of starch in which the laminate layer is comprised of natural or synthetic waxes or of a mixture of waxes.

EP 1195401 A1 describes also a laminated film in which the laminate layer is described as being selectively permeable for CO₂ and is made of poly(4-methyl pentene-1).

EP 0495950 discloses the manufacture of laminated films in which a hydrophobic polymer is vapor-deposited onto a hydrophilic starch film.

As in the case of laminated films made of synthetic materials, the disadvantages relating to a complex, expensive manufacture and lack of adhesion of the laminate layer on the base film apply to these laminates.

A high selective permeability for CO₂ and excellent barrier effect relative to water vapor is achieved according to DE 19613484 A1 also by single-layer films of blends of starch acetate and aliphatic straight-chain or branched polycarbonates. A disadvantage is that the starch acetate must first be manufactured in a complex process.

EP 0647184 discloses a multi-layer film of a moisture-sensitive polymer and thermally sensitive polymers and additional components.

WO 03/035753 (published May 1, 2003) discloses compositions in the form of a film comprised of the components destructured starch and polyhydroxy alkanoate copolymer (PHA) with a defined structure of at least two randomly repeating monomer units. This mixture is used inter alia for producing a laminated film in which at least one layer is comprised of this mixture.

In WO 9116375, Tomka describes the manufacture by coextrusion of a multi-layer film comprised of thermoplastically processable starch with a polyethylene layer or polypropylene layer and a bonding agent for improving adhesion between the layers.

DE 4116404 discloses a polymer mixture and hints at the possibility of using it for producing a water-resistant three-layer film by coextrusion. A blend of thermoplastic starch (TPS), polyolefin, and a polyethylene acrylate MSA copolymer is proposed for the outer layers of this film and thermoplastic starch for the middle layer. By adding borax, magnesium sulfate, and calcium carbonate, the water resistance can be further improved.

EP 0537657 B1 discloses a method for manufacturing a multi-layer film of TPS or a blend of TPS and polyolefins (polyethylene, polypropylene) by using compatibilizers or bonding agents in the form of a block copolymer.

EP 0479964 and U.S. Pat. No. 6,242,102 each disclose a multi-layer film comprised of thermoplastically processable starch that contains at least 20% by weight of an additive and an additional layer of a polyolefin or a polymer blend of starch and polyolefins. As coating variants, coating with silicon monoxide and the application of alkyl siloxanes are mentioned also.

The base material of these last mentioned multi-layer films are comprised of biodegradable starch but, disadvantageously, all these films contain also polyolefins, for example, polyethylene or polypropylene or other materials that are not biodegradable.

The processing technology of stretching known in connection with plastic films cannot be applied easily to films of starch because as a result of the stretching process a phase separation of the starch and the other polymer phase takes place which leads to unusable films.

EP 0537657 B1 traces these bad stretching properties back to the high water contents of the known starch blends and proposes a method according to which the water contents of the employed starch blend that is permissible for coextrusion must be less than 1%. In order to obtain such a low water contents, the employed TPS must be dried from a water contents of approximately 18% to one of less than 1%. A disadvantage is that the drying process heavily stresses the material.

The object of the present intention is providing a multi-layer film for use in packaging which multi-layer film
is completely biodegradable,
has a minimal oxygen permeability,
is stretchable, and
has a defined barrier effect relative to N₂, CO₂, and water vapor.

According to the invention, this object is solved by a multi-layer film obtainable by coextrusion, that is comprised, respectively, of at least
a) one starch blend layer comprised of a modified thermoplastic starch blend and
b) one polyester layer comprised of a biodegradable polyester.

The film is comprised of at least two layers. Preferably, it is comprised of an inner layer that is surrounded by two outer layers.

As a result of the manufacturing process in which the materials for all layers are melted and the layers are formed simultaneously by coextrusion, the layers are fused across the complete interaction surface and are physically inseparably connected to one another.

The materials of the individual layers are selected such or matched to one another by additives such that they have comparable viscosity and melting properties.

The modified thermoplastic starch blend is comprised preferably of the following components:
30 to 75%, preferably 40 to 75%, starch
2 to 10% water
10 to 50% preferably 15 to 40%, biodegradable polyester,
5 to 20% compatibilizer,
up to 10% plasticizer,
up to 3% processing agent.

In order to increase flowability, up to 10% plasticizers, preferably glycerine, are admixed. The water contents acts as an additional plasticizer.

The modified starch blend is mainly responsible for the oxygen barrier effect; by variation of the thickness of this layer and of the starch contents the gas permeability can be adjusted.

The polyester in the modified starch blend as well as the polyester employed for the outer layer is preferably composed of dihydroxy compounds and dicarboxylic acids as monomers.

The polyester is especially preferred a statistic aliphatic-aromatic copolyester that is composed of the monomers butanediol, adipic acid and terephthalic acid or a purely aliphatic polyester that is composed of the monomers butanediol, succinic acid, and adipic acid. The proportion of terephthalic acid should not surpass 30% in order to ensure the biodegradability.

As an alternative, such a polyester can also be, for example, a polylactide or a blend of a polylactide and another polyester or a polyvinyl acetate (PVAc).

The starch blend layer contains no polyester of the following type: polyhydroxyalkanoate copolymer comprised of at least two randomly repeating monomer units, wherein a first monomer has the structure (I): 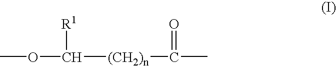
wherein R1 is H or a C1 or C2 alkyl group, with n=1 or 2;
wherein a second monomer has the structure (II): 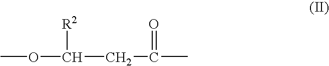
wherein R2 is a C3 to C₁₋₉ alkyl or C3 to C19 alkenyl group, or the second monomer has the structure (III) 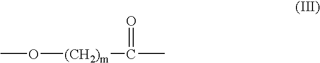
wherein m is from 2 to 9.

The two outer layers and the polyester proportion in the starch blend can be composed of the same polyester material or different polyester materials or a mixture of polyester materials, respectively.

The polyester forming the outer layers is mainly responsible for the barrier effect against water vapor. By variation of the thickness of the outer layer, the water vapor permeability can be adjusted.

As the compatibilizers or phase intermediating agent preferably polymer components are used that contain hydrophilic and hydrophobic groups arranged in blocks, respectively. The compatibilizer contains especially preferred a block-saponified polyvinyl acetate (DE 19750846). Alternatively, other compatibilizers such as “Lotader”, CDT Chemie; “Novatec”, Mitsubishi Chemicals, Japan; “Surleyn”, DuPont, USA; or “Lonly”, MitsuiToatsu, Japan, can be used. As compatibilizers, polymers with reactive groups such as epoxy or acid anhydride groups that react during processing with the starch can also be used (EP 0596437 B2).

Surprisingly, it was found that the effect of the compatibilizer is not only important for the stability of the blend but also for the strength of the adhesive layer between the inner and outer layers of the multi-layer film. This is based presumably on the fact that the hydrophilic and hydrophobic block segments of the compatibilizing agent migrate into the phase boundary layer and increase adhesion in this way.

Inter alia, eruca acid amide (for example, Loxamid E of the firm Cognis), stearic acid (Edenor L2SM of the firm Cognis), glycerine mono stearate (Edenor GMS 50/2 of the firm Cognis) can be used as processing agents.

Preferably, the total thickness of the film is 10 μm to 300 μm. In this connection, an outer layer preferably has a thickness between 1 μm to 100 μm. The thickness of the inner layer is preferably between 5 μm and 250 μm.

Preferably, the inner layer is two times to 10 times thicker than an outer layer.

The film according to the present intention is characterized by the following advantageous properties:
excellent tear strength,
excellent stretching properties,
stretching capability (up to a factor of 1:5),
excellent sealing capability,
complete biodegradability;
safe for food.

According to the invention, the multi-layer film is produced by a method of coextrusion in which, respectively, at least one
a) layer comprised of a modified thermoplastic starch blend and
b) layer comprised of a biodegradable polyester are formed simultaneously.

The method of coextrusion including the variants of blow coextrusion and wide slot extrusions are known in general. Both variants can be alternatively employed for the method according to the invention. Preferably, blow coextrusion is used.

The method according to the invention is characterized in that for the structure of the layers materials are selected that have specially matched melting and viscosity properties and in that the starch blend layer contains more than 1% to 10% water.

Preferably, the materials have a viscosity with an MFI value between 4 g to 10 g per 10 minutes at 130° C. and 10 kg load or 5 g to 40 g per 10 minutes at 160° C. and 10 kg load.

The modified thermoplastic starch blend is guided through a barrier screw having a cross hole mixing device and a melt filter.

The temperature of the starch blend should not surpass 160° C. because the bonded water would otherwise evaporate, a decomposition of the starch would take place, and the phase stability of the blend would be disturbed.

The extruder is preferably operated at a stepped gradient so that for the starch blend component a temperature between 100° C. and 130° C. is maintained. Especially preferred, the starch blend is melted first at approximately 110° C., is then heated to 130° C., cooled to 125° C., and then heated again for extrusion to 135° C.

For producing the polyester layer, preferably the temperature in the extruder is kept between 120° C. and 140° C. Especially preferred, the polyester is melted first at approximately 120° C., then heated to 150° C., cooled to 140° C., and is kept at this temperature up to the step of extrusion.

When employing polylactides for the polyester layer, temperatures of 150° C. to 190° C. are necessary.

Surprisingly, the modified starch blend may contain in the inventive method up to 8% to 10% water without the water being evaporated during processing and bubbles being formed.

Advantageously, the materials of which the layers are comprised must not be dried before processing.

During extrusion, the film is preferably blown at a ratio of 1:3 to 1:5. The blow ratio refers to the ratio of the diameter of the die in the blow head and the film width at the end of the process.

Surprisingly, for a blow ratio of 1:5 no phase separation or layer separation occurs.

The following parameters are often tightly interwoven in regard to the morphological characteristics and cannot be varied independently of one another:
type, size of the extruder,
weight ratios of the components in the starch blend,
screw geometry,
temperature, residence time,
shearing speed,
viscosity ratio of the components under the shearing conditions,
duration of shearing load,
boundary surface energy.

Surprisingly, it was found that the Na acetate residues of approximately 1.5-3.0% by weight remaining upon manufacture of the compatibilizer act as a water binding agent in the blend and therefore do not disturb the coextrusion.

Especially surprising is that the film, despite the high water contents of the starch material, exhibits excellent stretching properties.

The films can be stretched at a ratio of 1:3 to 1:5 mono-axially as well as biaxially. No phase separation between the starch blend and the polyester components of the layers is observed. Preferably, the films are stretched at a ratio up to 1:5, preferred up to 1:4. Stretching can be carried out in a temperature range of 30° C. to 70° C. Preferably, stretching is carried out at a temperature between 40° C. to 60° C.

Advantageously, stretching increases the tensile strength and reduces the expansibility of the film.

The invention also includes the utilization of the multi-layer film according to the invention for packagings, in particular for food.

The invention will be explained in more detail with the aid of the following embodiments.

### EXAMPLE 1

In the following examples, the following products are used for producing the polyesters or starch blend layer.

Ecoflex FBX 7011, BASF, Ludwigshafen, is a statistic aliphatic-aromatic copolyester composed of the monomers butanediol, adipic acid, and terephthalic acid. The proportion of terephthalic acid is less than 30%.

PLA 4042 D, Cargill Dow LLC, USA, is a polylactide.

BIOPar® 9345, BIOP Biopolymer Technologies AG, Dresden, is a starch blend comprised of starch, compatibilizers, glycerine, processing agents and a variable proportion of a polyester.

BIOPar® 9345/15 contains:
approximately 40% to 50% starch,
10% to 20% compatibilizer,
1% to 3% processing agent,
20% to 50% EcoFlex FBX 7011 (MFI 10)
10% glycerine.

The following starch blends are composed analogously but contain different proportions of polyester:

BIOPar® 9345/31 contains 50% EcoFlex FBX 7011 (MFI 10)

BIOPar® 9345/30 contains 40% EcoFlex FBX 7011 (MFI 10)

BIOPar® 9312/23 contains 30% EcoFlex FBX 7011 (MFI 10)

BIOPar® 9313/24 contains 20% EcoFlex FBX 7011 (MFI 10)

In the following table the viscosities and melting temperatures of the components used for the layer structure of the multi-layer films are compared.

| | melt viscosity | melt viscosity | |
|---|---|---|---|
| | MFI at 130° C. | MFI at 160° C. | melting |
| | and 10.0 kg load | and 10.0 kg load | temperature |
| component | (g/10 min) | (g/10 min) | (DSC) (° C.) |
| Ecoflex FBX | 5.4 | 33.5 | 110-115 |
| 7011 (MFI 3) | | | |
| Ecoflex FBX | 10 | appr. 40 | 1 10-1 15 |
| 7011 (MFI 10) | | | |
| BIOPar ® | 9.1 | 18.8 | |
| 9345/31 | | | |
| BIOPar ® | 8.8 | 18.7 | |
| 9345/30 | | | |
| BIOPar ® | 8.2 | 18.7 | |
| 9345/15 | | | |
| BIOPar ® | 4.3 | 9.6 | |
| 9712/23 | | | |
| BIOPar ® | 1.4 | 5.2 | |
| 9713/24 | | | |
| Ecoflex | 6.9 | appr. 19 | |
| (3/10)* | | | |
| PLA 4042 D | — | 3.8 | 200 |
| blend of 75% | — | 33 | |
| Ecoflex (3/10)* | | | |
| and 25% PLA | | | |
| 4042 D | | | |
| blend of 60% | — | 26.5 | |
| Ecoflex (3/10)* | | | |
| and 40% PLA | | | |
| 4042 D | | | |
| blend of 45% | — | 17.2 | |
| Ecoflex (3/10)* | | | |
| and 55% PLA | | | |
| 4042D | | | |

*Ecoflex (3/10) defines a blend of 50% Ecoflex FBX 7011 (MFI 10) and 50% Ecoflex FBX 7011 (MFI 3).

### EXAMPLE 2

Described is the manufacture of a three-layer film of the type ABA wherein the outer and inner layer (A) is comprised of a biodegradable polyester Ecoflex FBX 7011 and the middle layer (B) is comprised of the starch blend BIOPar® 9345-30 or BIOPar® 9345-15.

The manufacture is carried out with a Coex-3 layer blow film device of the firm Windmöller & Hölscher of the type Varex®; Optifil Plus, Filmatic-K dual winder.

This device is equipped with the following components.
extruder A, Varex®, 60.30 D for the outer layer Ecoflex FBX 7011;
extruder B, Varex®, 90.30 D for the middle layer BIOPar® 9345-30 with an LTS screw 37021001;
extruder C, Varex®, 60.30 D for the inner layer Ecoflex FBX 7011;
metering devices for the granular materials and conveying screws with special mixing and homogenization zones and screen changers;
a blown film die for three-layer films having a die diameter of 280 mm, a gap width of 0.8 mm

A film width of 1,530 mm and film thickness of 40 μm is achieved for the following parameters:
total material throughput to 169.6 kg/h,
pressure outside 280 bar, middle 247 bar, inside 250 bar, and
temperatures:
   cylinder filter outside:-120-140-150-140-140-140° C.
   cylinder filter middle:-100-120-130-130-130-125-125-130° C.
   cylinder filter inside:-120-140-150-140-140-140° C.
   blow die temperature 130° C.
removal speed 17.7 m/min
blow ratio 1:3.5 to 1:5.

### EXAMPLE 3

Described is the manufacture of a three-layer film of the type ABA having a layer composition in analogy to Example 2 with the difference that the manufacture is performed on a layer blow film device of the firm Kuhne, machine No. 2000-140312-0100; KFB 45-70-1.6000 BC.

This device is equipped with the following components:
an outer extruder K 45-24 D C for the outer layer of Ecoflex FBX 7011,
a main extruder K 70-30 D-B with barrier screw for the middle layer of BIOPar® 9345-30,
an inner extruder K 45-24 D C for the inner layer of Ecoflex FBX 7011,
metering devices for the granular materials, and
a blown film die for three-layer films, die diameter 220 mm, die gap 1.0 mm, and
appropriate removal systems.

A film width of 880 mm to 1000 mm and film thickness of 30 μm is achieved for the following parameters:
total material throughput: 125 kg/h at
pressure: outside 135 bar, middle 260 bar, inside 195 bar, and
temperatures:
   cylinder filter outside-120-140-150-140-140-140° C.,
   cylinder filter middle-100-120-130-130-130-125-125-130° C.,
   cylinder filter inside-120-140-150-140-140-140° C.,
   blow die temperature 130° C.,
blow ratio is 1:2 to 1:4,
removal speed 20 m/min.

### EXAMPLE 4

Described is the manufacture of a three-layer film of the type ABA having a layer composition in analogy to example 2 with the difference that the manufacture is performed on a research device of the firm BFA Plastic GmbH, Rossdorf.

This device is equipped with the following components:
an outer extruder BFA 30-25, LD 1:25, PE screw with mixing head for the outer layer of Ecoflex FBX 7011,
a main extruder of the type Battenfeld Uni-Ex 1-45-25 B, LD 1:25, with barrier screw, screw diameter 45 mm, PE screw and Maddock element for the middle layer of BIOPar® 9345-30,
an inner extruder BFA 30-25, LD 1:25, PE screw with mixing head for the inner layer of Ecoflex FBX 7011,
metering devices for the granular materials in the form of ConPro Gravimetric Feedhoppers Type KTW G3, and
a blown film die for mono-layer or 3-5 layer films, die diameter 80 mm, die gap 1.0 mm, and
appropriate removal systems.

A film width of 450 mm to 8000 mm and film thickness of 30 μm to 50 μm is achieved for the following parameters:
total material throughput 20 kg/h at
pressure: outside 220 bar, middle 380 bar, inside 220 bar, and
   temperatures:
   cylinder filter outside:-140-151-155-145-142° C.
   cylinder filter middle:-110-140-140-135-135° C.
   cylinder filter inside:-140-151-155-145-142° C.
   blow die temperature 130° C.
blow ratio 1:3.2
removal speed 8 m/min.

### EXAMPLE 5

In the following table the mechanical properties of three-layer films of the type ABA produced in analogy to Example 4 are compared as a function of the composition of the starch blend for the middle layer B (variation polyester components). For the outer and inner layers A the biodegradable polyester Ecoflex (3/10) was used, respectively.

The films each have a mass ratio of the layers A:B:A of 10:80:10 and a total thickness of 50 μm. They were produced at a removal speed of 8 m per minute and a blow ratio of 1:3.2 to 1:3.3.

| composition of | measuring | modulus of | tensile strength | elongation | tear strength | impact strength |
|---|---|---|---|---|---|---|
| middle layer B | direction | elasticity (MPa) | (MPa) | at tear (%) | (cN/mm) | (J/mm) |
| Biopar 9345/30 | extrusion | 130 | 12.1 | 393 | 608 | 2.92 |
| containing 40% | expansion | 171 | 13.0 | 495 | 1184 | |
| Ecoflex (3/10) | | | | | | |
| Biopar 9712/23 | extrusion | 171 | 10.7 | 226 | 464 | 3.0 |
| containing 30 | expansion | 129 | 10.2 | 346 | 880 | |
| Ecoflex (3/10) | | | | | | |
| Biopar 9713/24 | extrusion | 222 | 7.1 | 64 | 272 | 0.8 |
| containing 20% | expansion | 161 | 6.2 | 82 | 400 | |
| Ecoflex (3/10) | | | | | | |

See Example 1 for product compositions.

When varying the composition of the middle layer B, the mechanical properties can be affected significantly, for example, by the polyester proportion in the starch blend.

### EXAMPLE 6

In the following table, the mechanical properties of three-layer films of the type ABA produced in analogy to Example 4 are compared as a function of the composition of the biodegradable polyester employed for the inner and outer layers A. For these layers a polyester was used that is comprised of the components Ecoflex (3/10) and the poly lactide PLA 4042 D. Column 1 shows the mass proportion of the component PLA 4042 D. The rest of the polyester is comprised of Ecoflex (3/10), respectively. The starch blend Biopar 9345/30 was used for the middle layer, respectively.

The films have a mass ratio of layers A:B:A of 15:70:15 and a total thickness of 50 μm. They were removed at a removal speed of 8 m per minute and a blow ratio of 1:3.5.

| mass proportion | | | | | | |
|---|---|---|---|---|---|---|
| of PLA 4042 D in | measuring | modulus of | tensile strength | elongation | tear strength | impact strength |
| the layers A (%) | direction | elasticity (MPa) | (MPa) | at tear (%) | (cN/mm) | (J/mm) |
| 25 | extrusion | 134 | 13.1 | 386 | 816 | 4.00 |
| | expansion | 74 | 10.9 | 397 | 1344 | |
| 40 | extrusion | 328 | 14.5 | 286 | 1312 | 8.04 |
| | expansion | 123 | 11.0 | 256 | 2560 | |
| 55 | extrusion | 603 | 16.5 | 238 | 533 | 10.80 |
| | expansion | 190 | 10.0 | 104 | 2507 | |
| 100 | extrusion | 989 | 20.6 | 60 | 3111 | 8.71 |
| | expansion | 993 | 20.0 | 53 | 5600 | |

By varying the composition of the polyester components in the layers that surround the starch blend, the mechanical properties can be significantly improved.

### EXAMPLE 7

In the following table the permeation ratios for the gases O₂, N₂, CO₂ according to DIN 53380 and water vapor according to DIN 53122 (dated 1992) of three-layer films of the type ABA produced in the analogy to Example 2 are compared as a function of
the composition of the starch blend for the middle layer B (rows 2, 3, 5),
stretching (rows 6 and 7),

humidity (row 8).

| | | | | gas permeation (cm³/m² × day × | | | water vapor permeation |
|---|---|---|---|---|---|---|---|
| | | film thickness | relative | bar) according to DIN 53380 | | | (g/(m² × day) according |
| | composition | (μm) | humidity (%) | O₂ | N₂ | CO₂ | to DIN 53122 |
| 1 | Ecoflex FBX 70111 | | | 1600* | | | 140 |
| | (data from BASF) | | | | | | |
| 2 | BIOPar ® 37.7 | 50 | 40 | 95 | | | — |
| | (30% Ecoflex) | | 85 | 1100 | | | |
| 3 | BIOPar ® 9345/15 | 47 | 40 | 14-95 | | | 148 |
| | (40% Ecoflex) | | 85 | 1035 | | | |
| 4 | A: Ecoflex (3/10) | 45 | 40 | 12 | | | 121 |
| | B: BIOPar ® 9345/15 | | 85 | 720 | | | |
| | A: Ecoflex (3/10) | | | | | | |
| 5 | A: Ecoflex (3/10) | 30 | 40 | 41 | | | 57 |
| | B: BIOPar ® 9383 | | 85 | 770 | | | |
| | A: Ecoflex (3/10) | | | | | | |
| 6 | A: Ecoflex (3/10) | 70 | 40 | 18 | | | 110 |
| | B: BIOPar ® 9345/15 | | 85 | 685 | | | |
| | A: Ecoflex (3/10) | | | | | | |
| 7 | A: Ecoflex (3/10) | 35 | 50 | 128 | | | |
| | B: BIOPar ® 9345/15 | | | | | | |
| | A: Ecoflex (3/10) | | | | | | |
| 8 | A: Ecoflex (3/10) | 55 | 0 | 19 | 95 | 116 | |
| | B: BIOPar ® 9345/15 | | 52 | 134 | 50 | 1662 | |
| | A: Ecoflex (3710)* | | 85 | 474 | 157 | 4169 | |

For a comparison with the multi-layer films, in rows 1 and 2 and 3 data of mono-layer films made of polyester Ecoflex FBX 7011, the starch blends BIOPar® 37.7 (30% polyester), and BIOPar® 9345/15 (40% polyester) are listed.

The three-layer films of the type ABA listed in rows 4 to 8 are comprised of an inner and outer layer A Ecoflex (3/10)*, respectively. The composition of the starch blend used for the middle layer B is listed in the table (more information regarding the product compositions can be taken from Example 1).

The three-layer films have a mass ratio of the layers A:B:A of 10:80:10.

The film listed in row 5 contains in the starch blend layer 4% of a coloring agent; the starch blend is otherwise identical to that of rows 3 and 4. The film listed in row 6 is of the same composition as that of row 4 but has a greater thickness.

The composition and manufacture of the films in row 7 correspond to that of row 6 with the difference that the film was stretched at 60° C. at a ratio of 1:3.

When comparing the mono-layer films in rows 1 and 3, the increase of the polyester proportion leads to a strong reduction of the O₂ permeation.

The coloring agent proportion of 4% increases only the O₂ permeation values and has no effect on the other measured parameters.

The mono-axial stretching increases the O₂ permeation values.

In all films, the increase of permeation values for O₂ and water vapor at 85% relative humidity relative to the values measured at 40% is significant. Row 8 shows that with increasing humidity the permeation values increase generally, also for N₂ and CO₂.

### EXAMPLE 8

In the following table the mechanical properties of three-layer films of the type ABA produced in analogy to Example 4 are compared as a function of the ratio of the layer thickness of inner, middle and outer layers.

For the outer and inner layer A, the biodegradable polyester Ecoflex (3/10) was used, respectively. For the middle layer, the starch blend Biopar 9345/30 was used.

The films have a total thickness of 50 μm, respectively. They were produced at a removal speed of 8 m per minute and a blow ratio of 1:3.5.

In column 1, the mass ratio of the layers A:B:A is provided as mass for the ratio of air thicknesses.

| mass ratio | measuring | modulus of | tensile strength | elongation | tear strength | impact strength |
|---|---|---|---|---|---|---|
| A:B:A | direction | elasticity (MPa) | (MPa) | at tear (%) | (cN/mm) | (J/mm) |
| 10:80:10 | extrusion | 62 | 13.9 | 555 | 1176 | 3.44 |
| | expansion | 64 | 13.1 | 579 | 1344 | |
| 20:60:20 | extrusion | 64 | 15.5 | 587 | 15424 | 3.04 |
| | expansion | 64 | 15.5 | 527 | 4064 | |
| 25:50:25 | extrusion | 61 | 16.5 | 573 | 13984 | 3.24 |
| | expansion | 63 | 15.2 | 534 | 14304 | |

By varying the mass ratios of the layers, the tensile strength and tear strength are improved significantly while the elongation at tear surprisingly remains constant.

### EXAMPLE 9

In the following table the mechanical properties of three-layer films of the type ABA produced in analogy to Example 2 (rows 1 and 2) and in analogy to Example 3 (rows 3 and 4) are compared as a function of the die gap and the removal speed.

For the outer and inner layer A the biodegradable polyester Ecoflex (3/10) was used, respectively. For the middle layer the starch blend Biopar 9345/15 (row 1 and 2) or Biopar 9345/30 (rows 3 and 4) are used.

The films have a mass ratio between layers A:B:A of 11:78:11 (rows 1 and 2) and 10:80:10 (rows 3 and 4).

An important parameter that differentiates the devices used in Example 2 (rows 1 and 2) and in Example 3 (rows 3 and 4) is the die gap of the blow die:
Example 2 (rows 1 and 2): 0.8 mm

Example 3 (rows 3 and 4): 1.0 mm

| | removal speed | total thickness | | measuring | modulus of | tensile strength | elongation | tear strength | impact strength |
|---|---|---|---|---|---|---|---|---|---|
| | (m/min) | (μm) | blow ratio | direction | elasticity (MPa) | (MPa) | at tear (%) | (cN/mm) | (J/mm) |
| 1 | 32.0 | 30 | 1:3.4 | extr.* | 49 | 19.9 | 718 | 6044 | 2.60 |
| 2 | 17.6 | 50 | 1:3.4 | extr.* | 125 | 16.2 | 1085 | 693 | 4.2 |
| 3 | 30.3 | 30 | 1:2.5 | extr.* | 118 | 13.7 | 274 | 1013 | 3.2 |
| | | | | exp.* | 106 | 10.2 | 467 | 4213 | |
| 4 | 21.3 | 30 | 1:3.6 | extr.* | 114 | 11.7 | 361 | 5813 | 2.67 |
| | | | | exp.* | 90 | 10.6 | 446 | 2933 | |

*extr. = extrusion; exp. = expansion

The results show clearly that for a die gap of 0.8 mm (rows 1 and 2) in comparison to 1 mm (rows 3 and 4) significantly improved mechanical properties are obtained. A further improvement of these properties is realized by increased removal speeds.

### EXAMPLE 10

In the following table the stretchability of a three-layer film of the type ABA produced in analogy to Example 2 and the effect of a subsequent stretching of the film on the mechanical properties of the film is explained.

For the outer and inner layer A, the biodegradable polyester Ecoflex (3/10) was used, respectively, and for the middle layer the starch blend Biopar 9345/15.

The starting film was produced at a removal speed of 11.3 m per minute and a blow ratio of 1:3.4.

Stretching was carried out mono-axially at 60° C. at a stretching ratio of 1:3.

| | | | | elon- | | |
|---|---|---|---|---|---|---|
| total | | | tensile | gation | tear | impact |
| thick- | stretch- | measuring | strength | at tear | strength | strength |
| ness | ing | direction | (MPa) | (%) | (cN/mm) | (J/mm) |
| 70 μm | no | extrusion | 18.2 | 894 | 1067 | 6.03 |
| 35 μm | yes | extrusion | 43 to 55 | 442 | — | — |

By a subsequent stretching action, the tensile strength of the film is significantly improved.

### EXAMPLE 11

The manufacture of a two-layer film of the type AB is described wherein the outer layer (A) is comprised of a biodegradable polyester Ecoflex FBX 7011 and the inner layer (B) is comprised of the starch blend BIOPar® 9345-30.

The manufacture is realized in analogy to Example 4 with the difference that the device is equipped with only two extruders.

### EXAMPLE 12

The manufacture of a three-layer film of the type ABC is described wherein the outer layer (A) is comprised of the biodegradable polyester Ecoflex FBX 7011, the middle layer (B) of the starch blend BIOPar® 9345-30, and the inner layer of the polylactide PLA 4042 D.

The manufacture is realized in analogy to Example 4 with the difference that the extruder C for the polylactide C is operated at approximately 150° C. to 190° C.

What is claimed is:

1.-23. (canceled)

24. A coextruded multi-layer film comprised of:
a) at least one starch blend layer comprised of a modified thermoplastic starch blend that contains more than 1% to 10% water; and
b) at least one polyester layer comprised of a biodegradable polyester;
wherein the starch blend layer contains no polyhydroxyalkanoate copolymer consisting of at least a first and a second randomly repeating monomer units, wherein the first monomer unit has the structure (I): 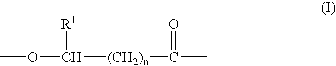
wherein R1 is H or a C1 or C2 alkyl group, with n=1 or 2;
wherein the second monomer unit has the structure (II): 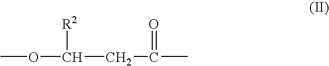
wherein R2 is a C3 to C₁₋₉ alkyl or C3 to C19 alkenyl group, or
the second monomer has the structure (III) 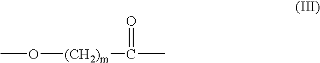
wherein m is from 2 to 9.

25. The multi-layer film according to claim 24, wherein the at least one starch blend layer is surrounded by two of the at least one polyester layer.

26. The multi-layer film according to claim 24, wherein the modified thermoplastic starch blend is comprised of:
30% to 75% starch,
2% to 10% water,
10% to 50% biodegradable polyester,
5% to 20% compatibilizer,
up to 10% plasticizer, and
up to 3% processing agent.

27. The multi-layer film according to claim 26, wherein the compatibilizer comprises a polymer component having hydrophilic and hydrophobic groups arranged in blocks, respectively.

28. The multi-layer film according to claim 27, wherein the compatibilizer comprises a hydrolyzed polyvinyl acetate that is saponified in blocks.

29. The multi-layer film according to claim 26, wherein the plasticizer is glycerine.

30. The multi-layer film according to claim 24, having a total thickness in a range of between 10 μm to 300 μm.

31. The multi-layer film according to claim 30, wherein the at least one polyester layer has a thickness between 1 μm to 100 μm.

32. The multi-layer film according to claim 30, wherein the at least one starch blend layer has a thickness between 5 μm to 250 μm.

33. The multi-layer film according to claim 30, wherein the at least one starch blend layer is two times to 10 times thicker than the at least one polyester layer.

34. The multi-layer film according to claim 24, wherein the biodegradable polyester is comprised of dihydroxy compounds and dicarboxylic acids as monomers.

35. The multi-layer film according to claim 34, wherein the monomers of the biodegradable polyester are butanediol, adipic acid, and terephthalic acid; or butanediol, succinic acid, and adipic acid.

36. The multi-layer film according to claim 24, wherein the at least one polyester layer comprises a polylactide; or a blend of a polylactide and another polyester; or a polyvinyl acetate.

37. A method for manufacturing a multi-layer film according to claim 24, the method comprising the step of coextruding a) at least one layer of a modified thermoplastic starch blend and b) at least one layer comprised of a biodegradable polyester, wherein the modified thermoplastic starch blend and the biodegradable polyester have comparable melting and viscosity properties and wherein the modified thermoplastic starch blend contains more than 1% to 10% water.

38. The method according to claim 37, wherein the modified thermoplastic starch blend and the biodegradable polyester materials have a viscosity of an MFI value between 4 g to 10 g per 10 minutes at 130° C. and 10 kg load.

39. The method according to claim 37, wherein the modified thermoplastic starch blend and the biodegradable polyester materials have a viscosity of an MFI value between 5 g to 40 g per 10 minutes at 160° C. and 10 kg load.

40. The method according to claim 37, wherein the temperature of the modified thermoplastic starch blend is kept between 90° C. to 140° C.

41. The method according to claim 37, wherein the temperature of the biodegradable polyester is kept between 110° C. to 150° C.

42. The method according to claim 37, wherein the temperature of the biodegradable polyester comprising polylactides is kept between 150° C. and 190° C.

43. The method according to claim 37, wherein the step of coextruding is a blow extruding step.

44. The method according to claim 43, wherein in the blow extruding step a blow ratio of 1:2 to 1:5 is used and a removal speed of 8 m to 30 m per minute is employed.

45. The method according to claim 37, further comprising the step of stretching after the step of coextruding.

46. The method according to claim 45, wherein the step of stretching is carried out at a temperature of the multi-layer film between 40° C. and 80° C.

47. The method according to claim 45, wherein in the step of stretching a stretching ratio of up to 1:5 is used.
